(19) United States
(12) Patent Application Publication
(10) Pub. No.: US 2025/0246682 A1
(43) Pub. Date: Jul. 31, 2025

(54) ELECTROLYTE SOLUTION FOR LITHIUM SECONDARY BATTERY AND METHOD OF PREPARING SAME

(71) Applicants: Hyundai Motor Company, Seoul (KR); Kia Corporation, Seoul (KR); Korea Advanced Institute of Science and Technology, Daejeon (KR)

(72) Inventors: Hui Beom Nam, Suwon (KR); Yoon Sung Lee, Suwon (KR); Sung Ho Ban, Hwaseong (KR); Tae Rim Lee, Hwaseong (KR); Jun Ki Rhee, Seoul (KR); Yong Ho Lee, Incheon (KR); Hyeon Gyu Moon, Daejeon (KR); Nam-Soon Choi, Daejeon (KR)

(21) Appl. No.: 18/825,174

(22) Filed: Sep. 5, 2024

(30) Foreign Application Priority Data
Jan. 30, 2024 (KR) 10-2024-0014308

(51) Int. Cl. H01M 10/0567; H01M 4/02; H01M 4/58; H01M 10/0525; H01M 10/0568; H01M 10/0569

(52) U.S. Cl. CPC H01M 10/0567; H01M 4/5825; H01M 10/0525; H01M 10/0568; H01M 10/0569; H01M 2004/028; H01M 2300/0051

(57) ABSTRACT

The present disclosure is an electrolyte solution for a lithium secondary battery and a method of preparing the same. The electrolyte solution enhances the output performance and high-temperature life characteristics of a lithium secondary battery, especially a lithium secondary battery including LiFePO₄ (LFP)-based positive electrode active material, using 1-(trimethylsilyl)-1H-benzotriazole and similar additives.

### CROSS REFERENCE TO RELATED APPLICATION(S)

The present application claims under 35 U.S.C. § 119 (a) the benefit of Korean Patent Application No. 10-2024-0014308, filed on Jan. 30, 2024, the entire contents of which is incorporated herein for all purposes by this reference.

### BACKGROUND

### Technical Field

The present disclosure relates to an electrolyte solution for a lithium secondary battery and a method of preparing the same, the electrolyte solution being capable of improving the output performance and high-temperature life characteristics of a lithium secondary battery, especially a lithium secondary battery including LiFePO₄ (LFP)-based positive electrode active material, using 1-(trimethylsilyl)-1H-benzotriazoleand the like included as an additive.

### Background

Lithium secondary batteries are widely utilized in portable energy storage devices, electric vehicles, and similar applications due to their numerous advantages: high energy density, low costs, long cycle life, and safety. Consequently, the development of lithium secondary batteries having high energy density and long-term life continues to attract attention.

Such a lithium secondary battery is composed of four key elements: a positive electrode, a negative electrode, a separator, and an electrolyte. The characteristics of these materials determine battery performance. Recently, battery ignition and explosion issues in the market of electric vehicles (EVs), energy storage systems (ESSs), and the like where medium to large-sized batteries are used are becoming an obstacle to market growth.

Furthermore, the commercialization of electric vehicles necessitates low costs, rapid charging/discharging capabilities, and advanced safety technologies. In this context, the performance of electrolyte solvents and additives for lithium-ion batteries is increasingly emphasized to enhance both battery performance and safety.

LiFePO₄ (LFP)-based positive electrode active materials do not structurally change upon charging. Additionally, LFP-based positive electrodes having an olivine-based structure with excellent thermal stability in a charged state exhibit low electrical conductivity (2.6×10⁻⁹ S/cm, cf. up to 10⁻³ S/cm in the case of LiCoO₂ (LCO)-based positive electrodes) because lithium ions may not easily move due to oxygen having a structure that is strongly bound in a hexagonal form.

LFP-based positive electrode active materials have excellent thermal stability due to the three-dimensional olivine structure, which involves strong P—O covalent bonds and does not structurally change upon charging. Furthermore, structural changes do not occur even with heat application in the charged state.

When reducing the particle size of such LFP-based positive electrode active materials to nano sizes, the movement distance of lithium ions is shortened, thereby improving the rate capability.

However, the capacity (theoretical capacity: 170 mAh/g for FePO₄) and voltage plateau (around 3.2 to 3.4 V) are low, and the electronic and ionic conductivities are low due to the characteristics of olivine-based positive electrodes. In particular, energy efficiency decreases significantly at low temperatures.

To address these challenges, there is a pressing need to develop an electrolyte system that enhances the high-temperature storage performance, low-temperature output characteristics, and long-term life performance of lithium secondary batteries utilizing LFP-based positive electrode active materials.

The information disclosed in this Background of the present disclosure section is only for enhancement of understanding of the general background of the present disclosure may not be taken as an acknowledgement or any form of suggestion that this information forms the related art already known to a person skilled in the art.

### SUMMARY

In one aspect, an electrolyte solution for a lithium secondary battery of the present disclosure includes an N-(alkylsilyl)benzotriazole compound as an additive. In preferred aspects, the additive is an N-(tri-C1-6alkylsilyl)benzotriazole compound such as 1-(trimethylsilyl)-1H-benzotriazole.

The present disclosure aims to provide an electrolyte solution for a lithium secondary battery and a method of preparing the same, the electrolyte solution being capable of improving the output performance and high-temperature life characteristics of a lithium secondary battery, especially a lithium secondary battery including LiFePO₄ (LFP)-based positive electrode active material, using an N-(alkylsilyl)benzotriazole compound such as 1-(trimethylsilyl)-1H-benzotriazole as an additive.

Technical problems to be solved by the present disclosure are not limited to the technical problems mentioned above, and it will be apparent that other technical problems not mentioned can be clearly understood by those skilled in the art from the description of the present disclosure.

An electrolyte solution for a lithium secondary battery of the present disclosure, which has been made to solve the problems described above, is characterized by including: a lithium salt; an organic solvent; and an additive including an N-(alkylsilyl)benzotriazole compound, particularly an N-(tri-alkylsilyl)benzotriazole such as 1-(trimethylsilyl)-1H-benzotriazole. In some embodiments, the organic solvent may be non-aqeuous.

For example, the organic solvent may be characterized by including at least one organic solvent selected from the group consisting of ethylene carbonate, ethyl methyl carbonate (EMC), dimethyl carbonate (DMC), and a mixture thereof.

For example, the lithium salt may be characterized by including LiPF₆.

For example, the lithium salt may be characterized by being included in the electrolyte solution at a concentration in a range of 0.8 to 3.0 M.

For example, 1-(trimethylsilyl)-1H-benzotriazole may be characterized by being included in an amount in a range of 0.05 to 0.2 wt % based on the total weight of the electrolyte solution.

For example, the additive may be characterized by further including vinylene carbonate.

For example, vinylene carbonate may be characterized by being included in an amount in a range of 1.0 to 2.5 wt % based on the total weight of the electrolyte solution.

For example, the additive may be characterized by further including 1,3-propane sultone.

For example, 1,3-propane sultone may be characterized by being included in an amount in a range of 1.0 to 1.5 wt % based on the total weight of the electrolyte solution.

In certain aspects, the solvent component may be an organic solvent component. In such aspects, the solvent component may contain less than 20, 15, 10, 8, 7, 5, 4, 3, 2 or 0.5 volume percent water based on total volume of the solvent component, and the solvent component is comprised of a single solvent or an admixture of two or more distinct organic solvents. Preferred organic solvents present in the solvent components will be polar solvents and more preferably water-miscible organic solvents.

A method of preparing an electrolyte solution for a lithium secondary battery, which has been made to solve the problems described above, is characterized by including: preparing an organic solvent; and adding a lithium salt and an additive to the organic solvent, in which the additive includes 1-(trimethylsilyl)-1H-benzotriazole. In some embodiments, the organic solvent may be non-aqeuous.

For example, the organic solvent may be characterized by including at least one organic solvent selected from the group consisting of ethylene carbonate, ethyl methyl carbonate (EMC), dimethyl carbonate (DMC), and a mixture thereof.

For example, the lithium salt may be characterized by including LiPF₆.

For example, in the adding, the lithium salt may be characterized by being added such that a concentration thereof is in a range of 0.8 to 3.0 M based on the electrolyte solution.

For example, in the adding, 1-(trimethylsilyl)-1H-benzotriazole may be characterized by being added such that an amount thereof is in a range of 0.05 to 0.2 wt % based on the total weight of the electrolyte solution.

For example, the additive may be characterized by further including vinylene carbonate.

For example, in the adding, vinylene carbonate may be characterized by being added such that an amount thereof is in a range of 1.0 to 2.5 wt % based on the total weight of the electrolyte solution.

For example, the additive may be characterized by further including 1,3-propane sultone.

For example, in the adding, 1,3-propane sultone may be characterized by being added such that an amount thereof is in a range of 1.0 to 1.5 wt % based on the total weight of the electrolyte solution.

A lithium secondary battery, which has been made to solve the problems described above, is characterized by including: the electrolyte solution of the present disclosure; and a positive electrode including a positive electrode active material.

For example, the positive electrode active material in the positive electrode may be characterized by including a compound represented by Formula 1.

LiFeMPO₄ [Formula 1]
wherein, M is Ni, Co, Mn, Cr, Zr, Nb, Cu, V, Ti, Zn, Al, Ga, or Mg.

The present disclosure enables a protective layer to be formed on the surfaces of positive and negative electrodes using an electrolyte solution for a lithium secondary battery including an additive an N-(alkylsilyl)benzotriazole compound, particularly an N-(tri-alkylsilyl)benzotriazole such as 1-(trimethylsilyl)-1H-benzotriazole, thereby improving the output performance and high-temperature life characteristics of a lithium secondary battery, especially a lithium secondary battery including a LiFePO₄ (LFP)-based positive electrode active material.

In a further aspect, vehicles are provided that comprise an electrolyte as disclosed herein.

In a yet further aspect, vehicles are provided that comprise a secondary battery as disclosed herein.

Effects that can be achieved by the present disclosure are not limited to the effect mentioned above, and other effects that are not mentioned above but can be achieved by the present disclosure can be clearly understood by those skilled in the art from the description below.

### BRIEF DESCRIPTION OF THE DRAWINGS

FIG. 1 is a diagram illustrating the structural formula of 1-(trimethylsilyl)-1H-benzotriazole, an additive included in an electrolyte solution for a lithium secondary battery of the present disclosure;

FIG. 2 is a diagram illustrating the structural formula of vinylene carbonate, an additive included in an electrolyte solution for a lithium secondary battery of the present disclosure;

FIG. 3 is a diagram illustrating the structural formula of 1,3-propane sultone, an additive included in an electrolyte solution for a lithium secondary battery of the present disclosure;

FIG. 4 is a diagram showing a method of preparing an electrolyte solution for a lithium secondary battery according to one exemplary embodiment of the present disclosure; and

FIG. 5 is a graph showing the discharge capacity of batteries at varying cycles of charging and discharging in examples and comparative examples.

### DETAILED DESCRIPTION

All terms or words used in the specification and claims have the same meaning as commonly understood by those skilled in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

An electrolyte solution for a lithium secondary battery of the present disclosure includes an N-(alkylsilyl)benzotriazole compound, particularly an N-(tri-alkylsilyl)benzotriazole such as 1-(trimethylsilyl)-1H-benzotriazole as an additive, which is a compound having a functional group containing silyl-ether. This compound, included as the additive, removes HF, which causes various side reactions in the electrolyte solution, and forms a protective layer on the surfaces of negative and positive electrodes. Additionally, vinylene carbonate, further included as the additive, stabilizes the protective layer formed on the surface of the negative electrode, and 1,3-propane sultone, further included as the additive, stabilizes the protective layer formed on the surface of the positive electrode. The present disclosure relates to an electrolyte solution for a lithium secondary battery and a method of preparing the same, the electrolyte solution being capable of improving the output performance and high-temperature life characteristics of a lithium secondary battery, especially an LFP-based lithium secondary battery, by including these additives.

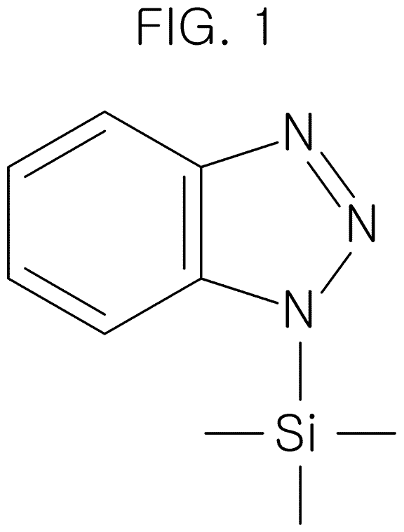

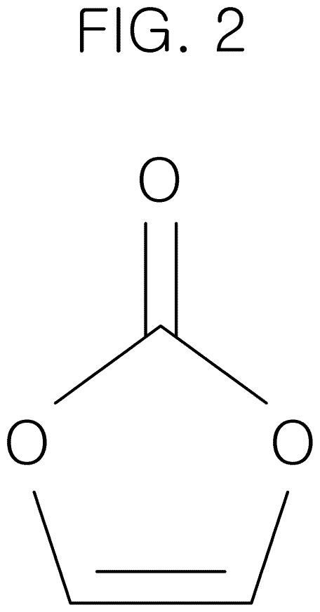

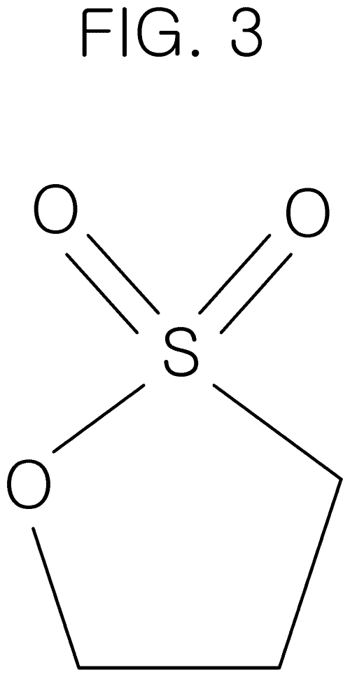

FIG. 1 is a diagram illustrating the structural formula of 1-(trimethylsilyl)-1H-benzotriazole, the additive included in the electrolyte solution for the lithium secondary battery of the present disclosure, FIG. 2 is a diagram illustrating the structural formula of vinylene carbonate, the additive included in the electrolyte solution for the lithium secondary battery of the present disclosure, and FIG. 3 is a diagram illustrating the structural formula of 1,3-propane sultone, the additive included in the electrolyte solution for the lithium secondary battery of the present disclosure. With reference to FIG. 1, FIG. 2 and FIG. 3, the electrolyte solution for the lithium secondary battery of the present disclosure will be described.

The electrolyte solution for the lithium secondary battery of the present disclosure may include: a lithium salt; an organic solvent; and the additives including 1-(trimethylsilyl)-1H-benzotriazole.

This additive, 1-(trimethylsilyl)-1H-benzotriazole having a functional group containing silyl-ether, may be effective in removing HF, which causes various side reactions in the electrolyte solution.

Additionally, 1-(trimethylsilyl)-1H-benzotriazole has high highest-occupied molecular orbital (HOMO) and low lowest-unoccupied molecular orbital (LUMO) energy levels. This enables 1-(trimethylsilyl)-1H-benzotriazole to form a film that protects a negative electrode by being decomposed on the surface of a negative electrode and to form a nitrogen-based cathode electrolyte interphase (CEI) layer with excellent high-temperature durability on a positive electrode.

This approach can prevent the elution of transition metals from the positive electrode. Additionally, it may reduce the self-discharge rate of the secondary battery. As a result, the high-temperature durability and cycle performance may be improved, thereby improving the high-temperature durability performance of the battery.

Additionally, the electron-rich triazole structure of 1-(trimethylsilyl)-1H-benzotriazole may enable a coordination structure to be formed effectively in the electrolyte solution such that Fe²⁺ ions eluted from a LiFePO₄ (LFP)-based positive electrode active material are kept from being electrodeposited on the negative electrode. Additionally, this structure may prevent the hydrolysis reaction of LiPF₆ salt from occurring through PF₅ stabilization, thereby improving the high-temperature life characteristics of the lithium secondary battery.

Such nature may enable the electrolyte solution to improve the high-temperature storage performance, low-temperature output characteristics, and long-term life performance of the lithium secondary battery using the LFP-based positive electrode active materials having low electronic and ionic conductivities.

Specifically, an N-(alkylsilyl)benzotriazole compound, particularly an N-(tri-alkylsilyl)benzotriazole such as 1-(trimethylsilyl)-1H-benzotriazole may be included in an amount in a range of 0.025 to 0.5 wt %, which is preferably in the range of 0.05 to 0.2 wt %, based on the total weight of the electrolyte solution.

This may be because when the amount of an N-(alkylsilyl)benzotriazole compound, particularly an N-(tri-alkylsilyl)benzotriazole such as 1-(trimethylsilyl)-1H-benzotriazole is lower than the above numerical range, the stability of a solid electrolyte interphase (SEI) film increases, which is insufficient to prevent gas generation and an increase in resistance at high temperatures, and when the amount of an N-(alkylsilyl)benzotriazole compound, particularly an N-(tri-alkylsilyl)benzotriazole such as 1-(trimethylsilyl)-1H-benzotriazole is higher than the above numerical range, the thickness of the film to be formed is excessively large, leading to increased battery resistance during charging and discharging.

Additionally, as will be confirmed through examples to be described later, the excellent long-term life performance and high-temperature life characteristics may be obtainable in an environment where vinylene carbonate is included in an amount in a range of 1.0 to 2.5 wt %, and 1,3-propane sultone is included in an amount in a range of 1.0 to 1.5 wt %.

Additionally, the additive may further include vinylene carbonate.

A film formed on the negative electrode through an N-(alkylsilyl)benzotriazole compound, particularly an N-(tri-alkylsilyl)benzotriazole such as 1-(trimethylsilyl)-1H-benzotriazole may be stabilized by vinylene carbonate.

Specifically, vinylene carbonate may be included in an amount in a range of 1.0 to 2.5 wt % based on the total weight of the electrolyte solution.

As will be confirmed through examples to be described later, the electrolyte solution for the lithium secondary battery, including vinylene carbonate in the amount satisfying the above numerical range, may exhibit excellent performance.

Additionally, the additive may further include 1,3-propane sultone.

A film formed on the positive electrode through an N-(alkylsilyl)benzotriazole compound, particularly an N-(tri-alkylsilyl)benzotriazole such as 1-(trimethylsilyl)-1H-benzotriazole may be stabilized by 1,3-propane sultone.

Specifically, 1,3-propane sultone may be included in an amount in a range of 1.0 to 1.5 wt % based on the total weight of the electrolyte solution.

As will be confirmed through examples to be described later, the electrolyte solution for the lithium secondary battery, including 1,3-propane sultone in the amount satisfying the above numerical range, may exhibit excellent performance.

On the other hand, in the electrolyte solution for the lithium secondary battery of the present disclosure, any lithium salt commonly used in electrolyte solutions for lithium secondary batteries may be, without limitations.

For example, a cation of the lithium salt may include Li⁺, and an anion thereof may include at least one selected from the group consisting of F⁻, Cl⁻, Br⁻, I⁻, NO₃⁻, N(CN)₂⁻, BF₄, ClO₄⁻, AlO₄⁻, AlCl₄⁻, PF₆⁻, SbF₆⁻, AsF₆⁻, BF₂C₂O₄⁻, BC₄O₈⁻, PO₂F₂⁻, PF₄C₂O₄⁻, PF₂C₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (FSO₂)₂N⁻, CF₃CF₂ (CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

On the other hand, the concentration of the lithium salt may be appropriately adjusted within commonly accepted ranges. However, to obtain the optimal effect of forming an anti-corrosion film on the electrode surface, the lithium salt may be included in the electrolyte solution at a concentration in a range of 0.8 to 3.0 M, which is preferably in the range of 1.0 to 1.5 M.

This may be because when the concentration of the lithium salt is lower than the above numerical range, the conductivity of the electrolyte solution may decrease, leading to a deterioration in the performance of the electrolyte solution, and when the concentration of the lithium salt exceeds the above numerical range, the viscosity of the electrolyte solution may increase, leading to a decrease in the mobility of lithium ions and a deterioration in the wettability of the electrolyte solution.

On the other hand, the non-aqueous organic solvent serves as a medium through which ions involved in electrochemical reactions in the battery may move. As the organic solvent, any solvent capable of minimizing decomposition from oxidation reactions during the charging and discharging of secondary batteries may be used. These solvents should also enable the desired properties in combination with the additives, without limitation . . .

Specifically, as the non-aqueous organic solvent, a carbonate-based, ester-based, ether-based, ketone-based, alcohol-based, or aprotic solvent may be used alone or in combination by mixing the two or more types of solvents described above. Preferably, at least one among ethylene carbonate, ethyl methyl carbonate (EMC), and dimethyl carbonate (DMC) is used.

Of all non-aqueous organic solvents, at least one solvent selected from the group consisting of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and a mixture thereof may be used as the carbonate-based solvent.

As the ester-based solvent, at least one solvent selected from the group consisting of methyl acetate, ethyl acetate, n-propyl acetate, dimethyl acetate, methyl propionate, ethyl propionate, propyl propionate, decanolide, mevalonolactone, caprolactone, and a mixture thereof may be used.

As the ether-based solvent, at least one solvent selected from the group consisting of dimethyl ether, diethyl ether, dipropyl ether, methyl ethyl ether, methyl propyl ether, ethyl propyl ether, dibutyl ether, tetraglyme, diglyme, dimethoxyethane, 2-methyl tetrahydrofuran, tetrahydrofuran, and a mixture thereof may be used.

As the ketone-based solvent, cyclohexanone and the like may be used.

As the alcohol-based solvent, at least one solvent selected from the group consisting of ethyl alcohol, isopropyl alcohol, and a mixture thereof may be used.

As the aprotic solvent, at least one solvent selected from the group consisting of nitriles such as R—CN (where R is a straight-chain, branched-chain, or ring-structured hydrocarbon group having 2 to 20 carbon atoms and may have a double-bond aromatic ring or an ether bond), amides such as dimethylformamide, dioxolanes such as 1,3-dioxolane, and sulfolane may be used.

The non-aqueous organic solvent may be used alone or in combination by mixing one or more solvents described above. When used in combination by mixing one or more solvents, the mixing ratio may be appropriately adjusted depending on the desired battery performance, which is widely understood by those skilled in the art.

Alternatively, this organic solvent may include at least one solvent selected from the group consisting of a high-dielectric solvent and a low-boiling point solvent.

Specifically,
the choice of high-dielectric solvents is not particularly limited, provided they are commonly used within the relevant technical field. Suitable examples include cyclic carbonates such as ethylene fluoride carbonate, ethylene carbonate, propylene carbonate, butylene carbonate, and 1-fluoroethylene carbonate, as well as gamma-butyrolactone and their mixtures . . .

Examples of the low-boiling point solvent used may include chain carbonates, such as dimethyl carbonate, ethyl methyl carbonate, diethyl carbonate, and dipropyl carbonate, dimethoxyethane, diethoxyethane, fatty acid ether derivatives, and mixtures thereof.

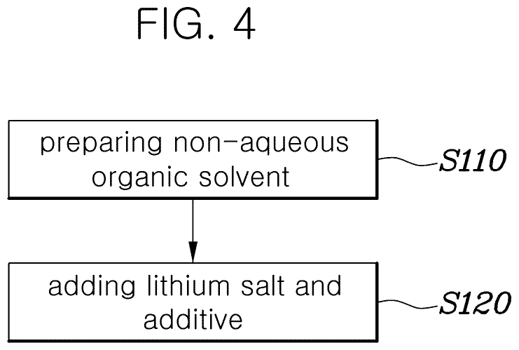

FIG. 4 is a diagram showing a method of preparing the electrolyte solution for the lithium secondary battery according to one exemplary embodiment of the present disclosure. With reference to FIG. 4, the method of preparing the electrolyte solution for the lithium secondary battery of the present disclosure will be described.

In the method of preparing the electrolyte solution for the lithium secondary battery of the present disclosure, S110 of preparing a non-aqueous organic solvent may be performed.

In the instant case, the non-aqueous organic solvent may include at least one non-aqueous organic solvent selected from the group consisting of ethylene carbonate, ethyl methyl carbonate (EMC), dimethyl carbonate (DMC), and a mixture thereof.

Additionally, a lithium salt may include LiPF₆. The lithium salt may be added such that a concentration thereof is in a range of 0.8 to 3.0 M, which is preferably in the range of 1.0 to 1.5 M, based on the electrolyte solution. This may be because when the concentration of the lithium salt is lower than the above numerical range, the conductivity of the electrolyte solution may decrease, leading to a deterioration in the performance of the electrolyte solution, and when the concentration of the lithium salt exceeds the above numerical range, the viscosity of the electrolyte solution may increase, leading to a decrease in the mobility of lithium ions and a deterioration in the wettability of the electrolyte solution.

Next, S120 of adding the lithium salt and an additive to the non-aqueous organic solvent may be performed.

In the instant case, the additive may include an N-(alkylsilyl)benzotriazole compound, particularly an N-(tri-alkylsilyl)benzotriazole such as 1-(trimethylsilyl)-1H-benzotriazole, and an N-(alkylsilyl)benzotriazole compound, particularly an N-(tri-alkylsilyl)benzotriazole such as 1-(trimethylsilyl)-1H-benzotriazole may be added such that an amount thereof included is in a range of 0.025 to 0.5 wt %, which is preferably in the range of 0.05 to 0.2 wt %, based on the total weight of the electrolyte solution.

As described above, this may be because when the amount of 1-(trimethylsilyl)-1H-benzotriazole is lower than the above numerical range, the increased stability of the solid electrolyte interface (SEI) film may still be insufficient to prevent gas generation and resistance at high temperatures. Conversely, a higher concentration results in an excessively thick SEI film, which leads to increased resistance during charging and discharging. Thus, the electrolyte solution for the lithium secondary battery, including 1-(trimethylsilyl)-1H-benzotriazole in the amount satisfying the above numerical range, may exhibit excellent performance.

Additionally, the additive may further include vinylene carbonate, and vinylene carbonate may be added such that an amount thereof included is in a range of 1.0 to 2.5 wt % based on the total weight of the electrolyte solution.

As will be confirmed through examples to be described later, the electrolyte solution for the lithium secondary battery, including vinylene carbonate within the specified numerical range, may demonstrate excellent performance.

On the other hand, the additive may further include 1,3-propane sultone, and 1,3-propane sultone may be added such that an amount thereof included is in a range of 1.0 to 1.5 wt % based on the total weight of the electrolyte solution.

As will be confirmed through examples to be described later, the electrolyte solution for the lithium secondary battery, including 1,3-propane sultone in the amount satisfying the above numerical range, may exhibit excellent performance.

Another embodiment of the present disclosure provides a lithium secondary battery including: a positive electrode including a positive electrode active material; a negative electrode including a negative electrode active material; and the electrolyte solution of the present disclosure.

In the instant case, the lithium secondary battery of the present disclosure may be manufactured by introducing a non-aqueous electrolyte solution of the present disclosure into an electrode structure composed of the positive electrode, the negative electrode, and a separator interposed between the positive and negative electrodes. In the instant case, all of those commonly used in the manufacturing of lithium secondary batteries may be usable as the positive electrode, negative electrode, and separator that constitute the electrode structure.

More specifically, the positive electrode active material in the lithium secondary battery of the present disclosure may include a compound represented by Formula 1.

LiFeMPO₄ [Formula 1]
wherein, M is Ni, Co, Mn, Cr, Zr, Nb, Cu, V, Ti, Zn, Al, Ga, or Mg.

First, the positive electrode may be manufactured by forming a positive electrode mixture layer on a positive electrode current collector. The positive electrode mixture layer may be formed by coating the upper portion of the positive electrode current collector with a positive electrode slurry including the positive electrode active material, a binder, a conductive additive, a solvent, and the like. This is followed by drying and rolling the resulting product to achieve the desired layer structure.

The positive electrode current collector is not particularly limited as long as it is conductive without causing chemical changes in batteries in the art. Examples thereof used may include stainless steel, aluminum, nickel, titanium, sintered carbon, or aluminum or stainless steel whose surface is treated with carbon, nickel, titanium, silver, and the like

The positive electrode active material, a compound enabling reversible lithiation and de-lithiation of lithium, may specifically include a lithium composite metal oxide containing lithium and one or more metals such as cobalt, manganese, nickel, or aluminum.

Examples of the lithium composite metal oxide may include lithium-manganese-based oxides (for example, LiMnO₂, LiMn₂O₄, and the like), lithium-cobalt-based oxides (for example, LiCoO₂ and the like), lithium-nickel-based oxides (for example, LiNiO₂ and the like), lithium-nickel-manganese-based oxides (for example, LiNi_{1-Y}Mn_{Y}O₂ (where 0<Y<1) and the like), lithium-nickel-manganese-cobalt oxides (for example, Li(NiₚCO_{q}Mnᵣ₁)O₂ (where 0<p<1, 0<q<1, 0<r1<1, and p+q+r1=1), Li(Niₚ₁Co_{q1}Mn₂)O₄ (where 0<p1<2, 0<q1<2, 0<r2<2, and p1+q1+r2=2), or the like), and lithium-nickel-cobalt-transition metal (M) oxides (for example, Li(Niₚ₂CO_{q2}Mnᵣ₃Mₛ₂)O₂ (where M is selected from the group consisting of Al, Fe, V, Cr, Ti, Ta, Mg, and Mo, and p2, q2, r3, and s2 are an atomic fraction of each independent element, wherein 0<p2<1, 0<q2<1, 0<r3<1, 0<s2<1, and p2+q2+r3+s2=1)). The lithium composite metal oxide may include any one or two or more of these compounds.

Among these compounds, given that the capacity characteristics and stability of the battery may be improved, the lithium composite metal oxide may be LiCoO₂, LiMnO₂, LiNiO₂, a lithium-nickel-manganese-cobalt oxide (for example, Li(Ni_{0.33}Mn_{0.33}Co_{0.33})O₂, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, Li(Ni_{0.8}Mn_{0.1}Co_{0.1})O₂, and the like), a lithium-nickel-cobalt oxide (for example, Li(Ni_{0.8}Co_{0.15}Al_{0.05})O₂ and the like), or the like.

Specifically, the positive electrode active material may include a compound represented by Formula 1.

LiFeMPO₄ [Formula 1]
wherein, M is Ni, Co, Mn, Cr, Zr, Nb, Cu, V, Ti, Zn, Al, Ga, or Mg.

The positive electrode active material may be included in an amount in a range of 80 to 99 wt % based on the total weight of a non-volatile phase in the positive electrode slurry.

The binder, a component that assists in bonding between the active material, the conductive additive, and the like as well as bonding to the current collector, may be typically added to an amount in a range of 1 to 30 wt % based on the total weight of the non-volatile phase in the positive electrode slurry.

Examples of such binders may include polyvinylidene fluoride (PVDF), polyvinyl alcohol (PVA), carboxymethyl cellulose (CMC), starch, hydroxypropyl cellulose (HPC), regenerated cellulose, polyvinylpyrrolidone (PVP), tetrafluoroethylene (TFE), polyethylene (PE), polypropylene (PP), ethylene-propylene-diene monomers (EPDM), sulfonated EPDM, styrene-butadiene rubber (SBR), fluorine rubber, and various copolymers.

The conductive additive is typically added to an amount in a range of 1 to 30 wt % based on the total weight of the non-volatile phase in the positive electrode slurry.

Such conductive additives are not particularly limited as long as they are conductive without causing chemical changes in batteries in the art.

Examples thereof used may include: graphite; carbon-based materials, such as carbon black, acetylene black, Ketjen black, channel black, furnace black, lamp black, and thermal black; conductive fibers, such as carbon fiber and metallic fiber; metal powders, such as fluorocarbon, aluminum, and nickel powders; conductive whiskers, such as zinc oxide and potassium titanate; conductive metal oxides, such as titanium oxide; and conductive materials, such as polyphenylene derivatives. Specific examples of currently available conductive additives include acetylene black series, such as products produced by Chevron Chemical or Denka black produced by Denka Singapore Private Limited, products produced by Gulf Oil, Ketjen black, EC series produced by Armak, Vulcan XC-72 produced by Cabot, and Super P produced by Timcal.

The solvent may include organic solvents such as N-methyl-2-pyrrolidone (NMP), which may be used in an amount that achieves a desirable viscosity when the positive electrode slurry includes the positive electrode active material and, optionally, the binder, the conductive additive, and the like.

For example, the non-volatile phase in the slurry, including the positive electrode active material and, optionally, the binder and the conductive additive, may be included such that a concentration thereof is in a range of 50 to 95 wt %, which is preferably in the range of 70 to 90 wt %.

Additionally, the negative electrode may be manufactured by forming a negative electrode mixture layer on a negative electrode current collector. The negative electrode mixture layer may be formed by coating the upper portion of the negative electrode current collector with a negative electrode slurry including a negative electrode active material, a binder, a conductive additive, a solvent, and the like. This is followed by drying and rolling the resulting product to achieve the desired layer structure.

The negative electrode current collector typically has a thickness in a range of 3 to 500 μm. Such a negative electrode current collector is not particularly limited as long as it is conductive without causing chemical changes in batteries in the art.

Examples thereof used may include copper, stainless steel, aluminum, nickel, titanium, sintered carbon, or copper or stainless steel whose surface is treated with nickel, titanium, silver, and the like.

Additionally, similar to the positive electrode current collector, the negative electrode current collector may enhance the bonding strength of the negative electrode active material by forming fine protrusions and depressions on the surface thereof. be It may be used in various forms of a film, sheet, foil, net, porous material, foams, and non-woven fabric.

Additionally, the negative electrode active material may include a single compound or a mixture of two or more selected from the group consisting of: lithium-containing titanium composite oxides (LTO); carbon-based materials, such as non-graphitizable carbon and graphite-based carbon; metal composite oxides, such as LiₓFe₂O₃ (where 0≤x≤1), LiₓWO₂ (where 0≤x≤1), and SnₓMe₁₋ₓMe′_{y}O_{z} (where Me is Mn, Fe, Pb, or Ge; Me′ is Al, B, P, Si, an element of groups 1, 2, and 3 of the periodic table, or a halogen; 0<x<1; 1<y<3; and 1<z<8); lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; and conductive polymers such as polyacetylene.

The negative electrode active material may be included in an amount in a range of 80 to 99 wt % based on the total weight of a non-volatile phase in the negative electrode slurry.

The binder, a component that assists in bonding between the conductive additive, active materials, and the current collector, may be typically added to an amount in a range of 1 to 30 wt % based on the total weight of the non-volatile phase in the negative electrode slurry.

Examples of such binders may include polyvinylidene fluoride (PVDF), polyvinyl alcohol (PVA), carboxymethyl cellulose (CMC), starch, hydroxypropyl cellulose (HPC), regenerated cellulose, polyvinylpyrrolidone (PVP), tetrafluoroethylene (TFE), polyethylene (PE), polypropylene (PP), ethylene-propylene-diene monomers (EPDM), sulfonated EPDM, styrene-butadiene rubber (SBR), fluorine rubber, and various copolymers thereof.

The conductive additive, employed to enhance the conductivity of the negative electrode active material, is typically added to an amount in a range of 1 to 20 wt % relative to the total weight of the non-volatile phase in the negative electrode slurry.

Such conductive additives are not particularly limited as long as they are conductive without causing chemical changes in batteries in the art.

Examples thereof used may include: graphite such as natural or artificial graphite; carbon black, such as acetylene black, Ketjen black, channel black, furnace black, lamp black, and thermal black; conductive fibers, such as carbon fiber and metallic fiber; metal powders, such as fluorocarbon, aluminum, and nickel powders; conductive whiskers, such as zinc oxide and potassium titanate; conductive metal oxides, such as titanium oxide; and conductive materials, such as polyphenylene derivatives.

The solvent may include water or organic solvents, such as NMP and alcohols, which may be used in an amount that achieves a desirable viscosity when the negative electrode slurry includes the negative electrode active material and, optionally, the binder, the conductive additive, and the like. For example, the non-volatile phase in the slurry, including the negative electrode active material and, optionally, the binder and the conductive additive, may be included such that a concentration thereof is in a range of 50 to 95 wt %, which is preferably in the range of 70 to 90 wt %.

The separator is a component serving to block the internal short-circuiting of both the electrodes and to impregnate the electrolyte. The separator may be formed by mixing a polymer resin, a filler, and a solvent to prepare a separator composition and then directly coating and drying the upper portion of the electrode with the separator composition to form a separator film. Alternatively, the separator composition may be cast and dried on a support, and the resulting separator film detached from the support may then be laminated on the electrode.

As the separator, a commonly used porous polymer film, for example, porous polymer films formed using a polyolefin-based polymer, such as ethylene homopolymers, propylene homopolymers, ethylene/butene copolymers, ethylene/hexene copolymers, and ethylene/methacrylate copolymers, may be used alone or in combination by laminating the polymer films mentioned above. Alternatively, an existing porous nonwoven fabric, for example, nonwoven fabrics made of polyethylene terephthalate fiber, glass fibers having high melting points, and the like, may be used. However, the separator is not limited thereto.

In the instant case, the porous separator may typically have a pore diameter in a range of 0.01 to 50 μm and a porosity in a range of 5% to 95%. Additionally, the porous separator may typically have a thickness in a range of 5 to 300 μm.

The appearance of the lithium secondary battery of the present disclosure is not particularly limited but may be manufactured into a cylindrical type using a can, prismatic type, pouch type, or coin type.

Hereinafter, although preferred exemplary examples are presented to aid in the understanding of the present disclosure, the following exemplary examples are disclosed only for illustrative purposes, and the present disclosure is not limited thereto.

### EXAMPLES AND COMPARATIVE EXAMPLES

### Example 1

A lithium secondary battery was manufactured by introducing 0.025 wt % of 1-(trimethylsilyl)-1H-benzotriazole (F5), 2.0 wt % of vinylene carbonate (VC), and 1.0 wt % of 1,3-propane sultone (PS) into an electrode structure of a positive electrode including LiFePO₄ (LFP) as a positive electrode active material, a negative electrode including graphite as a negative electrode active material, and a reference electrolyte solution.

In the instant case, a non-aqueous organic solvent in the reference electrolyte solution was prepared by adding 1.15 M LiPF₆ to a solvent in which ethylene carbonate (EC), ethyl methyl carbonate (EMC), and dimethyl carbonate (DMC) were mixed in a volume ratio of 30:60:10.

### Example 2

A lithium secondary battery was manufactured in the same manner as in Example 1, except for introducing 0.05 wt % of 1-(trimethylsilyl)-1H-benzotriazole (F5), 2.0 wt % of vinylene carbonate (VC), and 1.0 wt % of 1,3-propane sultone (PS).

### Example 3

A lithium secondary battery was manufactured in the same manner as in Example 1, except for introducing 0.1 wt % of 1-(trimethylsilyl)-1H-benzotriazole (F5), 2.0 wt % of vinylene carbonate (VC), and 1.0 wt % of 1,3-propane sultone (PS).

### Example 4

A lithium secondary battery was manufactured in the same manner as in Example 1, except for introducing 0.2 wt % of 1-(trimethylsilyl)-1H-benzotriazole (F5), 2.0 wt % of vinylene carbonate (VC), and 1.0 wt % of 1,3-propane sultone (PS).

### Example 5

A lithium secondary battery was manufactured in the same manner as in Example 1, except for introducing 0.3 wt % of 1-(trimethylsilyl)-1H-benzotriazole (F5), 2.0 wt % of vinylene carbonate (VC), and 1.0 wt % of 1,3-propane sultone (PS).

### Example 6

A lithium secondary battery was manufactured in the same manner as in Example 1, except for introducing 0.5 wt % of 1-(trimethylsilyl)-1H-benzotriazole (F5), 2.0 wt % of vinylene carbonate (VC), and 1.0 wt % of 1,3-propane sultone (PS).

### Example 7

A lithium secondary battery was manufactured in the same manner as in Example 1, except for introducing 0.1 wt % of 1-(trimethylsilyl)-1H-benzotriazole (F5), 1.0 wt % of vinylene carbonate (VC), and 1.0 wt % of 1,3-propane sultone (PS).

### Example 8

A lithium secondary battery was manufactured in the same manner as in Example 1, except for introducing 0.1 wt % of 1-(trimethylsilyl)-1H-benzotriazole (F5), 2.5 wt % of vinylene carbonate (VC), and 1.0 wt % of 1,3-propane sultone (PS).

### Example 9

A lithium secondary battery was manufactured in the same manner as in Example 1, except for introducing 0.1 wt % of 1-(trimethylsilyl)-1H-benzotriazole (F5), 2.0 wt % of vinylene carbonate (VC), and 1.5 wt % of 1,3-propane sultone (PS).

### Comparative Example 1

A lithium secondary battery was manufactured in the same manner as in Example 1, except for introducing 2.0 wt % of vinylene carbonate (VC) and 1.0 wt % of 1,3-propane sultone (PS) while not involving 1-(trimethylsilyl)-1H-benzotriazole (F5), that is, in an amount of 0 wt %.

### Comparative Example 2

A lithium secondary battery was manufactured in the same manner as in Example 1, except for introducing 1.0 wt % of vinylene carbonate (VC) and 1.0 wt % of 1,3-propane sultone (PS) while not involving 1-(trimethylsilyl)-1H-benzotriazole (F5), that is, in an amount of 0 wt %.

### Comparative Example 3

A lithium secondary battery was manufactured in the same manner as in Example 1, except for introducing 0.025 wt % of 1-(trimethylsilyl)-1H-benzotriazole (F5), 1.0 wt % of vinylene carbonate (VC), and 1.0 wt % of 1,3-propane sultone (PS).

### Comparative Example 4

A lithium secondary battery was manufactured in the same manner as in Example 1, except for introducing 0.05 wt % of 1-(trimethylsilyl)-1H-benzotriazole (F5), 1.0 wt % of vinylene carbonate (VC), and 1.0 wt % of 1,3-propane sultone (PS).

### Comparative Example 5

A lithium secondary battery was manufactured in the same manner as in Example 1, except for introducing 0.2 wt % of 1-(trimethylsilyl)-1H-benzotriazole (F5), 1.0 wt % of vinylene carbonate (VC), and 1.0 wt % of 1,3-propane sultone (PS).

### Comparative Example 6

A lithium secondary battery was manufactured in the same manner as in Example 1, except for introducing 2.5 wt % of vinylene carbonate (VC) and 1.0 wt % of 1,3-propane sultone (PS) while not involving 1-(trimethylsilyl)-1H-benzotriazole (F5), that is, in an amount of 0 wt %.

### Comparative Example 7

A lithium secondary battery was manufactured in the same manner as in Example 1, except for introducing 0.025 wt % of 1-(trimethylsilyl)-1H-benzotriazole (F5), 2.5 wt % of vinylene carbonate (VC), and 1.0 wt % of 1,3-propane sultone (PS).

### Comparative Example 8

A lithium secondary battery was manufactured in the same manner as in Example 1, except for introducing 0.05 wt % of 1-(trimethylsilyl)-1H-benzotriazole (F5), 2.5 wt % of vinylene carbonate (VC), and 1.0 wt % of 1,3-propane sultone (PS).

### Comparative Example 9

A lithium secondary battery was manufactured in the same manner as in Example 1, except for introducing 0.2 wt % of 1-(trimethylsilyl)-1H-benzotriazole (F5), 2.5 wt % of vinylene carbonate (VC), and 1.0 wt % of 1,3-propane sultone (PS).

### Comparative Example 10

A lithium secondary battery was manufactured in the same manner as in Example 1, except for introducing 3.0 wt % of vinylene carbonate (VC) and 1.0 wt % of 1,3-propane sultone (PS) while not involving 1-(trimethylsilyl)-1H-benzotriazole (F5), that is, in an amount of 0 wt %.

### Comparative Example 11

A lithium secondary battery was manufactured in the same manner as in Example 1, except for introducing 0.025 wt % of 1-(trimethylsilyl)-1H-benzotriazole (F5), 3.0 wt % of vinylene carbonate (VC), and 1.0 wt % of 1,3-propane sultone (PS).

### Comparative Example 12

A lithium secondary battery was manufactured in the same manner as in Example 1, except for introducing 0.05 wt % of 1-(trimethylsilyl)-1H-benzotriazole (F5), 3.0 wt % of vinylene carbonate (VC), and 1.0 wt % of 1,3-propane sultone (PS).

### Comparative Example 13

A lithium secondary battery was manufactured in the same manner as in Example 1, except for introducing 0.1 wt % of 1-(trimethylsilyl)-1H-benzotriazole (F5), 3.0 wt % of vinylene carbonate (VC), and 1.0 wt % of 1,3-propane sultone (PS).

### Comparative Example 14

A lithium secondary battery was manufactured in the same manner as in Example 1, except for introducing 0.2 wt % of 1-(trimethylsilyl)-1H-benzotriazole (F5), 3.0 wt % of vinylene carbonate (VC), and 1.0 wt % of 1,3-propane sultone (PS).

### Comparative Example 15

A lithium secondary battery was manufactured in the same manner as in Example 1, except for introducing 2.0 wt % of vinylene carbonate (VC) and 0.5 wt % of 1,3-propane sultone (PS) while not involving 1-(trimethylsilyl)-1H-benzotriazole (F5), that is, in an amount of 0 wt %.

### Comparative Example 16

A lithium secondary battery was manufactured in the same manner as in Example 1, except for introducing 0.025 wt % of 1-(trimethylsilyl)-1H-benzotriazole (F5), 2.0 wt % of vinylene carbonate (VC), and 0.5 wt % of 1,3-propane sultone (PS).

### Comparative Example 17

A lithium secondary battery was manufactured in the same manner as in Example 1, except for introducing 0.05 wt % of 1-(trimethylsilyl)-1H-benzotriazole (F5), 2.0 wt % of vinylene carbonate (VC), and 0.5 wt % of 1,3-propane sultone (PS).

### Comparative Example 18

A lithium secondary battery was manufactured in the same manner as in Example 1, except for introducing 0.1 wt % of 1-(trimethylsilyl)-1H-benzotriazole (F5), 2.0 wt % of vinylene carbonate (VC), and 0.5 wt % of 1,3-propane sultone (PS).

### Comparative Example 19

A lithium secondary battery was manufactured in the same manner as in Example 1, except for introducing 0.2 wt % of 1-(trimethylsilyl)-1H-benzotriazole (F5), 2.0 wt % of vinylene carbonate (VC), and 0.5 wt % of 1,3-propane sultone (PS).

### Comparative Example 20

A lithium secondary battery was manufactured in the same manner as in Example 1, except for introducing 2.0 wt % of vinylene carbonate (VC) and 1.5 wt % of 1,3-propane sultone (PS) while not involving 1-(trimethylsilyl)-1H-benzotriazole (F5), that is, in an amount of 0 wt %.

### Comparative Example 21

A lithium secondary battery was manufactured in the same manner as in Example 1, except for introducing 0.025 wt % of 1-(trimethylsilyl)-1H-benzotriazole (F5), 2.0 wt % of vinylene carbonate (VC), and 1.5 wt % of 1,3-propane sultone (PS).

### Comparative Example 22

A lithium secondary battery was manufactured in the same manner as in Example 1, except for introducing 0.05 wt % of 1-(trimethylsilyl)-1H-benzotriazole (F5), 2.0 wt % of vinylene carbonate (VC), and 1.5 wt % of 1,3-propane sultone (PS).

### Comparative Example 23

A lithium secondary battery was manufactured in the same manner as in Example 1, except for introducing 0.2 wt % of 1-(trimethylsilyl)-1H-benzotriazole (F5), 2.0 wt % of vinylene carbonate (VC), and 1.5 wt % of 1,3-propane sultone (PS).

### Comparative Example 24

A lithium secondary battery was manufactured in the same manner as in Example 1, except for introducing 2.0 wt % of vinylene carbonate (VC) and 2.0 wt % of 1,3-propane sultone (PS) while not involving 1-(trimethylsilyl)-1H-benzotriazole (F5), that is, in an amount of 0 wt %.

### Comparative Example 25

A lithium secondary battery was manufactured in the same manner as in Example 1, except for introducing 0.025 wt % of 1-(trimethylsilyl)-1H-benzotriazole (F5), 2.0 wt % of vinylene carbonate (VC), and 2.0 wt % of 1,3-propane sultone (PS).

### Comparative Example 26

A lithium secondary battery was manufactured in the same manner as in Example 1, except for introducing 0.05 wt % of 1-(trimethylsilyl)-1H-benzotriazole (F5), 2.0 wt % of vinylene carbonate (VC), and 2.0 wt % of 1,3-propane sultone (PS).

### Comparative Example 27

A lithium secondary battery was manufactured in the same manner as in Example 1, except for introducing 0.1 wt % of 1-(trimethylsilyl)-1H-benzotriazole (F5), 2.0 wt % of vinylene carbonate (VC), and 2.0 wt % of 1,3-propane sultone (PS).

### Comparative Example 28

A lithium secondary battery was manufactured in the same manner as in Example 1, except for introducing 0.2 wt % of 1-(trimethylsilyl)-1H-benzotriazole (F5), 2.0 wt % of vinylene carbonate (VC), and 2.0 wt % of 1,3-propane sultone (PS).

### Comparative Example 29

A lithium secondary battery was manufactured in the same manner as in Example 1, except for not involving all of 1-(trimethylsilyl)-1H-benzotriazole (F5), vinylene carbonate (VC), and 1,3-propane sultone (PS).

### Comparative Example 30

A lithium secondary battery was manufactured in the same manner as in Example 1, except for introducing 0.025 wt % of 1-(trimethylsilyl)-1H-benzotriazole (F5) while not involving both vinylene carbonate (VC) and 1,3-propane sultone.

### Comparative Example 31

A lithium secondary battery was manufactured in the same manner as in Example 1, except for introducing 0.05 wt % of 1-(trimethylsilyl)-1H-benzotriazole (F5) while not involving both vinylene carbonate (VC) and 1,3-propane sultone.

### Comparative Example 32

A lithium secondary battery was manufactured in the same manner as in Example 1, except for introducing 0.1 wt % of 1-(trimethylsilyl)-1H-benzotriazole (F5) while not involving both vinylene carbonate (VC) and 1,3-propane sultone.

### Comparative Example 33

A lithium secondary battery was manufactured in the same manner as in Example 1, except for introducing 0.2 wt % of 1-(trimethylsilyl)-1H-benzotriazole (F5) while not involving both vinylene carbonate (VC) and 1,3-propane sultone.

### Experimental Example

### (1) Evaluation of High-Temperature Life Capacity Retention Rate

The batteries manufactured in Examples 1 to 9 and Comparative Examples 1 to 33 were charged and discharged using the CC-CV charging method to compare discharge capacity.

Specifically, 200 cycles of charging and discharging were performed at a temperature of 45° C. and a C-rate of 1.0 C, and the discharge capacity of the battery was measured at each cycle.

The life capacity retention rate was calculated using Equation 1 below.

$$[ Equation 1 ]$$

$$Life capacity retention rate = [ \text{} Discharge capacity after 200 cycles of charging and discharging / Initial discharge capacity after 1 cycle of charging and discharging ]$$

### (2) Evaluation of Output Performance

The low-rate discharge capacity and high-rate discharge capacity of each battery manufactured in Examples 1 to 9 and Comparative Examples 1 to 33 were compared.

Specifically, at a temperature of 25° C., charging was performed at rates of 0.5° C. (low rate) and 4.0 C (high rate), and discharging was performed at a rate of 0.5 C, thereby measuring and comparing the discharge capacity depending on the rate.

The output performance was calculated using Equation 2 below.

$$[ Equation 2 ]$$

$$Output performance = [ \text{} Discharge capacity at rate of 4 C / Discharge capacity at rate of 0.5 C ]$$

TABLE 1

| | | | | High-temperature | Output |
|---|---|---|---|---|---|
| | | | | capacity | performance at x |
| | Additive (wt %) | | | retention rate (%) | C vs. 0.5 C (%) |
| | F5 | VC | PS | At 200 cycles | At 4 C |
| Comparative | | 2.0 | 1.0 | 85.5 | 79.7 |
| Example 1 | | | | | |
| Example 1 | 0.025 | 2.0 | 1.0 | 86.4 | 79.4 |
| Example 2 | 0.05 | 2.0 | 1.0 | 88.2 | 78.6 |
| Example 3 | 0.1 | 2.0 | 1.0 | 90.7 | 79.3 |
| Example 4 | 0.2 | 2.0 | 1.0 | 89.6 | 77.7 |
| Example 5 | 0.3 | 2.0 | 1.0 | 87.9 | 76.3 |
| Example 6 | 0.5 | 2.0 | 1.0 | 85.3 | 65.2 |
| Comparative | | 1.0 | 1.0 | 84.3 | 77.4 |
| Example 2 | | | | | |
| Comparative | 0.025 | 1.0 | 1.0 | 84.2 | 77.8 |
| Example 3 | | | | | |
| Comparative | 0.05 | 1.0 | 1.0 | 85.2 | 78.3 |
| Example 4 | | | | | |
| Example 7 | 0.1 | 1.0 | 1.0 | 87.3 | 79.2 |
| Comparative | 0.2 | 1.0 | 1.0 | 85.1 | 77.3 |
| Example 5 | | | | | |
| Comparative | | 2.5 | 1.0 | 85.0 | 75.1 |
| Example 6 | | | | | |
| Comparative | 0.025 | 2.5 | 1.0 | 84.9 | 76.2 |
| Example 7 | | | | | |
| Comparative | 0.05 | 2.5 | 1.0 | 85.3 | 74.5 |
| Example 8 | | | | | |
| Example 8 | 0.1 | 2.5 | 1.0 | 86.9 | 73.2 |
| Comparative | 0.2 | 2.5 | 1.0 | 83.2 | 69.3 |
| Example 9 | | | | | |
| Comparative | | 3.0 | 1.0 | 82.0 | 72.2 |
| Example 10 | | | | | |
| Comparative | 0.025 | 3.0 | 1.0 | 82.1 | 71.2 |
| Example 11 | | | | | |
| Comparative | 0.05 | 3.0 | 1.0 | 82.5 | 70.8 |
| Example 12 | | | | | |
| Comparative | 0.1 | 3.0 | 1.0 | 84.2 | 69.8 |
| Example 13 | | | | | |
| Comparative | 0.2 | 3.0 | 1.0 | 81.0 | 60.1 |
| Example 14 | | | | | |
| Comparative | | 2.0 | 0.5 | 85.3 | 76.8 |
| Example 15 | | | | | |
| Comparative | 0.025 | 2.0 | 0.5 | 85.3 | 75.3 |
| Example 16 | | | | | |
| Comparative | 0.05 | 2.0 | 0.5 | 84.1 | 74.2 |
| Example 17 | | | | | |
| Comparative | 0.1 | 2.0 | 0.5 | 83.1 | 71.9 |
| Example 18 | | | | | |
| Comparative | 0.2 | 2.0 | 0.5 | 81.7 | 68.1 |
| Example 19 | | | | | |
| Comparative | — | 2.0 | 1.5 | 84.2 | 77.1 |
| Example 20 | | | | | |
| Comparative | 0.025 | 2.0 | 1.5 | 84.5 | 74.8 |
| Example 21 | | | | | |
| Comparative | 0.05 | 2.0 | 1.5 | 85.3 | 73.9 |
| Example 22 | | | | | |
| Example 9 | 0.1 | 2.0 | 1.5 | 86.2 | 71.2 |
| Comparative | 0.2 | 2.0 | 1.5 | 84.2 | 68.8 |
| Example 23 | | | | | |
| Comparative | — | 2.0 | 2.0 | 83.0 | 76.2 |
| Example 24 | | | | | |
| Comparative | 0.025 | 2.0 | 2.0 | 83.1 | 74.9 |
| Example 25 | | | | | |
| Comparative | 0.05 | 2.0 | 2.0 | 83.5 | 72.1 |
| Example 26 | | | | | |
| Comparative | 0.1 | 2.0 | 2.0 | 83.9 | 70.1 |
| Example 27 | | | | | |
| Comparative | 0.2 | 2.0 | 2.0 | 81.2 | 65.8 |
| Example 28 | | | | | |
| Comparative | — | — | — | 83.6 | 76.7 |
| Example 29 | | | | | |
| Comparative | 0.025 | — | — | 83.8 | 74.9 |
| Example 30 | | | | | |
| Comparative | 0.05 | — | — | 84.4 | 73.0 |
| Example 31 | | | | | |
| Comparative | 0.1 | — | — | 85.7 | 70.7 |
| Example 32 | | | | | |
| Comparative | 0.2 | — | — | 82.7 | 67.3 |
| Example 33 | | | | | |

In Table 1, F5 stands for 1-(trimethylsilyl)-1H-benzotriazole, VC stands for vinylene carbonate, and PS stands for 1,3-propane sultone.

Each amount included based on the total weight of the electrolyte solution is expressed.

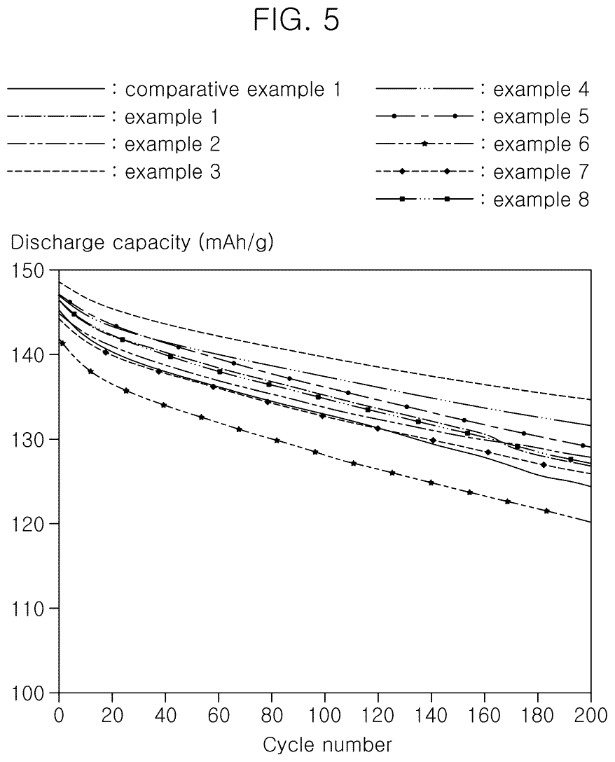

As shown in FIG. 5 and Table 1, it was confirmed that the lithium secondary batteries of Examples 1 to 9, in which 1-(trimethylsilyl)-1H-benzotriazole was included, exhibited excellent high-temperature capacity retention rate and output performance.

In particular, it was confirmed that the lithium secondary batteries of Examples 2 to 4, including 2.0 wt % of VC and 1.0 wt % of PS, showed even further excellent life capacity retention rate and output performance. From this, when the electrolyte solution for the lithium secondary battery of the present disclosure includes 2.0 wt % of VC and 1.0 wt % of PS, it was confirmed that 1-(trimethylsilyl)-1H-benzotriazole was able to effectively improve the high-temperature capacity retention rate and output performance of the lithium secondary battery.

The electrolyte solution for lithium secondary batteries described herein, which includes 1-(trimethylsilyl)-1H-benzotriazole, has been demonstrated to enhance both the output characteristics and high-temperature capacity retention rates. This improvement was confirmed through Examples 1 to 9, where lithium secondary batteries employing LiFePO₄ (LFP)-based positive electrode active material exhibited excellent performance. These results confirm that 1-(trimethylsilyl)-1H-benzotriazole, included in the electrolyte solution for the lithium secondary battery of the present disclosure, is capable of effectively removing HF that causes various side reactions in the electrolyte solution by having a functional group containing silyl-ether, of forming a protective layer on the surfaces of the negative electrode by being decomposed on the surface thereof, of forming a nitrogen-based cathode electrolyte interphase (CEI) layer having excellent high-temperature durability on the positive electrode to prevent transition metals from being eluted therefrom, and of improving the high-temperature durability and cycle performance by reducing the self-discharge of the secondary battery, thereby improving the high-temperature durability performance of the battery.

Additionally, the electron-rich triazole structure of 1-(trimethylsilyl)-1H-benzotriazole enables a coordination structure to be formed effectively in the electrolyte solution such that Fe²⁺ ions eluted from the positive electrode are kept from being electrodeposited on the negative electrode, thereby improving the life characteristics of the lithium secondary battery, especially the batteries using the LFP-based positive electrode active material. Furthermore, the nitrogen atom present in the molecular structure of 1-(trimethylsilyl)-1H-benzotriazole enables the LiPF₆ salt to be stabilized, thereby improving the high-temperature life characteristics of the battery.

Such nature confirms that the electrolyte solution of the lithium secondary battery of the present disclosure enhances the high-temperature storage performance, low-temperature output characteristics, and long-term life performance of the lithium secondary battery using the LFP-based positive electrode active material having low electronic and ionic conductivities.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed:

1. An electrolyte solution for a lithium secondary battery, the electrolyte solution comprising:
a lithium salt;
an organic solvent component; and
an additive comprising an N-(alkylsilyl)benzotriazole compound

2. The electrolyte solution of claim 1 wherein the additive comprises an N-(tri-alkylsilyl)benzotriazole compound.

3. The electrolyte solution of claim 1 wherein the additive comprises 1-(trimethyl)-1H-benzotriazole.

4. The electrolyte solution of claim 1, wherein the lithium salt comprises LiPF₆.

5. The electrolyte solution of claim 1, wherein the lithium salt is present pat a concentration in a range of 0.8 to 3.0 M.

6. The electrolyte solution of claim 1, wherein the organic solvent component comprises ethylene carbonate, ethyl methyl carbonate (EMC), dimethyl carbonate (DMC), and a mixture thereof.

7. The electrolyte solution of claim 1, wherein the N-(alkylsilyl)benzotriazole compound is present in an amount ranging from 0.05 to 0.2 wt % based on the total weight of the electrolyte solution.

8. The electrolyte solution of claim 1, wherein the additive further comprises vinylene carbonate.

9. The electrolyte solution of claim 8, wherein the vinylene carbonate is present in an amount ranging from 1.0 to 2.5 wt % based on the total weight of the electrolyte solution.

10. The electrolyte solution of claim 1, wherein the additive further comprises 1,3-propane sultone.

11. The electrolyte solution of claim 10, wherein the 1,3-propane sultone is present in an amount in a range of 1.0 to 1.5 wt % based on total weight of the electrolyte solution.

12. A method of preparing an electrolyte solution for a lithium secondary battery, the method comprising:
preparing an organic solvent; and
adding a lithium salt and an additive to the organic solvent,
wherein the additive comprises an N-(alkylsilyl)benzotriazole compound

13. The method of claim 12 wherein the N-(alkylsilyl)benzotriazole compound is 1-(trimethylsilyl)-1H-benzotriazole.

14. The method of claim 12, wherein the organic solvent comprises ethylene carbonate, ethyl methyl carbonate (EMC), dimethyl carbonate (DMC), and a mixture thereof.

15. The method of claim 12, wherein the lithium salt comprises LiPF₆.

16. The method of claim 12, wherein in the adding, the lithium salt is added such that its concentration in the electrolyte solution ranges from 0.8 to 3.0 M, and wherein in the adding, the N-(alkylsilyl)benzotriazole compound is added in an amount ranging from 0.05 to 0.2 wt % based on the total weight of the electrolyte solution.

17. The method of claim 12, wherein the additive further comprises vinylene carbonate.

18. The method of claim 12, wherein the additive further comprises 1,3-propane sultone.

19. A lithium secondary battery comprising:
the electrolyte solution of claim 1; and
a positive electrode comprising a positive electrode active material.

20. The lithium secondary battery of claim 19, wherein the positive electrode active material comprises LiFeMPO₄, wherein M is Ni, Co, Mn, Cr, Zr, Nb, Cu, V, Ti, Zn, Al, Ga, or Mg.
